(19) United States
(12) Patent Application Publication
(10) Pub. No.: US 2009/0178294 A1
(43) Pub. Date: Jul. 16, 2009

(54) Nitrogen filling grain storage devices

(76) Inventors: Feitian Luo, Nanning (CN); Shangqiang Tang, Fangchenggang (CN); Caiqing Ling, Fangchenggang (CN)

Correspondence Address: JACOBSON HOLMAN PLLC, 400 SEVENTH STREET N.W., SUITE 600, WASHINGTON, DC, 20004, US

(21) Appl. No.: 12/081,904

(22) Filed: Apr. 23, 2008

(30) Foreign Application Priority Data
Jan. 11, 2008 (CN) 200820000684.5

(51) Int. Cl. F26B 21/02

(52) U.S. Cl. 34/219

(57) ABSTRACT

The practical new invention is nitrogen filling grain storage device which relates to food storage area. The best way to store food is oxygen deaeration, however, maintaining the anaerobic environment through seal and vacuum in a great volume silo is hard to achieve because of many technical problems. The practical new invention adopts nitrogen grain storage technology. Nitrogen tank linked to pressure reducing valve, a flow meter and air intake circulation blower by pipeline, then enters grain piles through upside and bottom nitrogen circulation pipelines. Nitrogen spreads in the grain piles. The balanced nitrogen exhausts from the silo through nitrogen circulation outflow pipes and exhaust circulation fan. The nitrogen concentration can reach 98% after several nitrogen intake and exhaust. Stored grain in this atmosphere has the following beneficial effects: prominent grain storage effect, ability to kill all pests within 10 days, grain storage of up to 360 days and above. The device is simple, easy to operate, implement and promote in the majority of grain storage.

### TECHNICAL FIELDS

The present invention relates to food storage areas, particularly nitrogen filling grain storage.

### TECHNICAL BACKGROUND

Grain is an important guarantee for the survival of mankind, and we must produce more food in order to live a prosperous life. A long storage period exists from food production to consumption, so good food storage and low loss have been extensive attention. The main cautions of loss include moisture, temperature, oxygen, pest, microbial and enzyme activity. Water can be resolved by full exposure before grain entering the silo; temperature can be controlled by changing warehouse structures design; the hazards of pests, rodents, microorganisms and enzyme relates to life activities which are dependent on oxygen. And the absolute airtight silo and the deaerator will be able to eliminate the life phenomenon for food storage because Streptomyces are inhibited and insects and rodents can not survive. Sealing silo and food vacuum packaging is an effective way to good food storage, and will not cause environmental and food pollution. However, there are many technical problems for the large volume of food pile to the long-term vacuum sealed packaging. It is still hard to achieve. At present the industry is interested in the future of nitrogen grain storage, that is, exclude oxygen and store food in the atmosphere of nitrogen. This approach is the way we favor and attention.

### CONTENT OF THE INVENTION

The purpose of the practical new invention is to provide a simple, obvious effects, easy to implement and promotion nitrogen filling grain storage device.

To achieve the above objective technical plan are as follows:

Nitrogen filling grain storage devices, a sealed silo with nitrogen tank, are characterized by nitrogen tank linked to pressure reducing valve, a flow meter and intake air circulation blower by pipeline, and the outlet of the intake air circulation blower enters grain silos on the top and bottom of the grain piles through upside and bottom nitrogen circulation pipelines, which pierce the silo and are connected to exhaust circulation fan, equipped with a nitrogen detection mouth, while the outlet of exhaust circulation fan is connected to the exhaust pipe.

The nitrogen filling grain storage device described in claim 1, features the top in the grain pile covered with sealed plastic film connected to the wall sealing around the silos.

The nitrogen filling grain storage device described in claim 1, features a filter, dehumidification and cooling devices in front of nitrogen tank, or any one or two of these devices.

The technology uses conventional methods to get high purity nitrogen (99%) by the air separation and purification. Seal one side or 5 or 6 sides of the grain in the airtight grain pile with plastic film. There are inlet and exhaust circulation pipe network on top and bottom of the piles. After decompression high purity nitrogen enter the silo through the pipeline and circulation fan, and then spread to the entire grain pile through circulation pipeline network. Circulation makes nitrogen consistent and balanced throughout the grain piles. After repeated Nitrogen Filling and deflation in the granary, nitrogen gradually replaces oxygen. Concentration of nitrogen continuously increases and oxygen concentration steadily decrease until all positions Nitrogen concentrations are up to the required concentration. The concentration of nitrogen in the warehouse is regularly determined. Supplement nitrogen when the concentration of nitrogen is below than the required one in order to keep nitrogen concentration in the entire process of grain storage.

The practical new invention has the following beneficial effects:

1. Prominent grain storage effect: nitrogen concentration can be as high as 98% in the sealed Granary, this can kill all pests within 10 days; nitrogen concentration maintained at more than 92 percent for up to 120 days or more; during the entire nitrogen filling grain storage stage, food maintained without insects, food quality remains unchanged. Preservation of time can be effective in more than 360 days.

2. The installation is simple, easy to operate and implement in the grain silos.

3. The device doesn't produce pollution for the food and environment.

### BRIEF DESCRIPTION OF THE DRAWING

FIG. 1—the structure of practical new nitrogen filling grain storage device

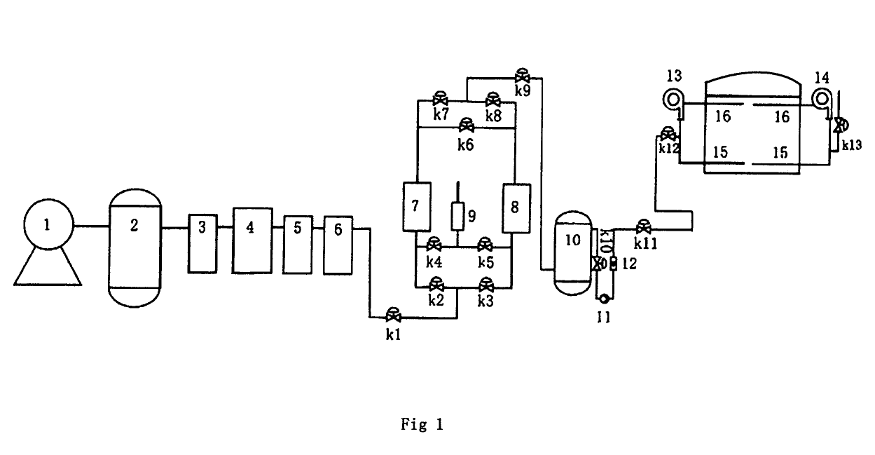

The name of the serial number in the Figure:

1—high-purity nitrogen, 2—nitrogen tank, 3—pressure reducing valve, 4—flow bucket, 5—air intake circulation blower, 6—silos, 7—sealed plastic membrane, 8—nitrogen circulation intake pipe on the top of grain, 9—nitrogen circulation intake pipe at the end of grain, 10—nitrogen circulation outflow pipe on the top of grain, 11—nitrogen circulation outflow pipe at the end of grain, 12—detection sampling outlet, 13—circulation exhaust fan, 14—exhaust pipes, 15—grain heap

### Specific Embodiments of the Invention

### EXAMPLE 1

Select the 8^{th} silo of a state grain reserves warehouse as a pilot grain storage warehouse, which is 42 m long, 30 m wide, hermetic for more than 300 seconds, the stored grain is the soft white wheat imported from United States which is 5,120 tons, the bulk density of 811 g/L, 10.2% moisture, 0.6% impurities, and normal grain temperature.

Warehouses pests: sample the pest population density on the 8^{th} warehouse before the trial. The major pest species are cryptolestes ferrugineus, oryzaephilus surinamensis, tribolium castaneum, liposcelis divinatorius, rhyzopertha dominica fbricius, and sitophilus zeamais motschulsky. And the pest population density is 35 pcs/kg.

Nitrogen generator equipment and working conditions: LU15E-8 screw air compressors supply compressed air for nitrogen generator. Air compressor parameters: gas production 2 m³/min, the output air pressure of 0.6 MPa; nitrogen generator model is CXG295-30, nitrogen 30 m³/hour, nitrogen purity was 99.5%, the output of nitrogen pressure of 0.4 MPa; 16 KWH power; filters, cold and dry machine, adsorption tower uses conventional equipment. Circulation model is BLZ-grade 11N02.3A, specifications: wind of 500 m³/h, 1 MPa air pressure. The top of Grain stack is covered with plastic film which is connected to the silo wall by rapid adhesive and fixed by plastic compaction devices nitrogen generator takes about 350 hours of work to fill 99.5% purity nitrogen 10,500 m³ into 8^{th} silo by 5 times. There are 78% nitrogen concentration and 21% oxygen concentration before filling nitrogen on the 8^{th} silo. After the end of nitrogen filling in the 8^{th} silo, nitrogen concentration increased to 98.12%, the oxygen concentration dropped to 1.82%, reaching the requirements of a pest's lethal concentration of 98%. After inspection; on the 8^{th} silo the original grain pests such as cryptolestes ferrugineus, oryzaephilus surinamensis, tribolium castaneum, liposcelis divinatorius, rhyzopertha dominica fbricius and sitophilus zeamais motschulsky. There found no live insects in the review in 90 days. Nitrogen concentration in the grain pile remains at 93.2%, the oxygen concentration of 6.8%. Food storage quality on the 8^{th} warehouses is superior to these in the non-nitrogen filling storage silos.

### EXAMPLE 2

Select the 3^{th} silo of a state grain reserves warehouse as a pilot grain storage warehouses, which is 72 m long, 30 m wide, hermetic for more than 300 seconds, the stored grain is the domestic Northeast yellow maize which is 9,227 tons, the bulk density of 712 g/L, 13.1% moisture, 0.6% impurities, and normal grain temperature.

Warehouses pests: sample the pest population density on the 3^{th} silo before the trial. The major pest species are sitophilus zeamais motschulsky, sitotroga cerealella, cryptolestes ferrugineus, carporhilus mutilatus erichson and Liposcelis divinatorius. And the pest population density is 20 pcs/kg.

The nitrogen generator is the same as the one in example one.

Nitrogen generator takes about 600 hours to fill 99.5% purity nitrogen 18,000 m³ into 3^{th} silo by 5 times. There are 78% nitrogen concentration and 21% oxygen concentration before filling nitrogen on the 3^{th} silo. After the end of nitrogen filling in the 3rd silo, nitrogen concentration increased to 98.30%, the oxygen concentration dropped to 1.70%, reaching the requirements of a pest's lethal concentration of 98%. After inspection the original grain pests such as carporhilus mutilatus erichson, cryptolestes ferrugineus, liposcelis divinatorius, sitophilus zeamais motschulsky and sitotroga cerealella have been killed on the 3^{th} silo. There found no live insects in the review in 90 days. Nitrogen concentration in the grain pile remains at 92.6%, the oxygen concentration of 7.4%. Food storage quality on the 3rd warehouses is superior to these in the non-nitrogen filling storage silos.

1. Nitrogen filling grain storage devices, a sealed silo with nitrogen tank, are characterized by nitrogen tank linked to pressure reducing valve, a flow meter and intake air circulation blower by pipeline, and the outlet of the intake air circulation blower enters grain silos on the top and bottom of the grain piles through upside and bottom nitrogen circulation pipelines, which pierce the silo and are connected to exhaust circulation fan, equipped with a nitrogen detection mouth, while the outlet of exhaust circulation fan is connected to the exhaust pipe.

2. The nitrogen filling grain storage device described in claim 1, features the top in the grain pile covered with sealed plastic film connected to the wall sealing around the silos.

3. The nitrogen filling grain storage device described in claim 1, features a filter, dehumidification and cooling devices in front of nitrogen tank, or any one or two of these devices.
